(19) United States
(12) Patent Application Publication
(10) Pub. No.: US 2007/0232189 A1
(43) Pub. Date: Oct. 4, 2007

(54) Honeybee hive, components, and extraction method

(76) Inventor: Max J. Hamby, Westmorland, CA (US)

Correspondence Address: CLEMENTS WALKER, 1901 ROXBOROUGH ROAD, SUITE 300, CHARLOTTE, NC, 28211, US

(21) Appl. No.: 11/397,456

(22) Filed: Apr. 4, 2006

(51) Int. Cl. A01K 51/00

(52) U.S. Cl. 449/2

(57) ABSTRACT

A method of extracting honey from a honeybee hive is disclosed, comprising: separating the honey super(s) containing the frames of honey from the remainder of the hive components; placing the entire honey super(s) in an extractor such that the top bar of said frames are closest to the wall of the extractor; and rotating the extractor sufficiently to extract the honey. The frames of honey are plastic fully drawn combs and are not uncapped prior to the rotating step. The honey super(s) is/are rotated 90° from its/their position in the hive. The honey super frames can comprise a unitary integral plastic frame and foundation having a top bar, 2 side bars and a bottom bar with said foundation positioned between all of said bars, said side bars having a width wider than the top bar and bottom bar so as to create bee space, said foundation having hexagonal dimples formed therein, each of said dimples having an integrally formed plastic honeybee egg positioned centrally.

### BACKGROUND OF THE INVENTION

1) Field of the Invention

The present invention relates to a hive and the components therein useful for raising honeybees and extracting honey should excess honey exist. The present invention includes frames made of 100% plastic and are unitary in the sense that the entire frame, including the plastic foundation or fully drawn comb, is cast from plastic, simultaneously, and thus are integral and one-piece. Furthermore, the frames are extra rigid in that they are thicker, but they also have reinforced steel in the areas of the ears which heretofore tended to break, in both wood and plastic frames. In an embodiment of the present invention, the entire honey super including the frames that have honey therein, can be simultaneously extracted, i.e. an extractor is constructed which can hold, for example, four complete honey super boxes with frames, inclusive. Additionally, a high speed method of extraction is disclosed wherein no uncapping of the comb is necessary.

2) Prior Art

Man has managed honeybees for thousands of years. And in earlier times, honey served as virtually the only source of sweetener. Today, the vast majority of beekeepers in the world use the Langstroth Hive System. The heart of this system consists of a box typically having removable frames with foundation, wherein each frame is spaced from one another by “bee space”. Prior to this time frames were not removable. This permits easy inspection of the hive for diseases as well as an easy extraction process, simply remove the frames of excess honey.

Until recently, all beekeepers use honeybee wax to make a thin sheet of foundation which has the imprint of the dimples of a hexagonal honeycomb and may typically be from about 4.9 mm across to about 6.25 mm across. The small 4.9-5.1 mm foundation has been employed recently for controlling varroa mites. 5.1-5.7 mm is fairly typical for worker bee comb and 5.7-5.8 mm is typical for drone comb. Greater than 5.8 mm is generally useful only as honey supers. These larger sizes have the advantage in that they hold more honey.

A typical hive consists of a bottom board which has an opening therein through which the bees can enter the hive body. The hive body is a rectangular box with typically 10 removable frames having foundation therein, and sits atop the bottom board. More than one hive bodies may be employed. On top of the uppermost hive body, sits one or more honey supers. The honey supers are not for brood rearing, but only for excess honey, that the beekeeper will extract. One or more honey supers may be employed depending on the year and success of the bees in making honey. On the top of the honey supers are typically an inner cover and an outer cover. The various components of a beehive (bottom board, hive body, honey super, inner cover and outer cover (with metal roof)) were typically constructed of wood, and the frames in the hive body and honey supers were also made of wood. The beeswax foundation secured within the frames having imprinted or stamped hexagonally shaped dimples allow the bees to draw or build on the dimples to make fully drawn combs. While wood has been used for over 100 years, plastics have recently been employed for not only the hive boxes, but also for the frames. Moreover, bottom boards, inner covers and outer covers are also starting to appear in the marketplace made from plastic, such as recycled plastic. Plastic rectangular honey supers boxes or hive body boxes are also available. Plastic foundation for use in wooden frames is unitarily extruded for both the frames in the hive bodies and for the frames in the honey supers. Moreover, plastic frames are also readily available but are notorious for the ears breaking. There are repair kits available which attempt to repair such broken ears.

U.S. Pat. No. 4,374,440 to Drapkin discloses an all plastic fully drawn frame useful for both the hive bodies and the honey supers. This product is commercially available under the tradename PermaComb. The draw-back of the product is its non-standard size. The box for holding the frames must be cut down to avoid burr comb building by the bees. If this is not done, separation of the hive components is very difficult as the burr comb must be broken, exposing honey, brood and pollen. This makes the bees very angry and difficult to handle. More a common problem with this frame is the tendency for the ears to break, rendering the frame useless.

There exists a need for a hive with plastic components, including foundation or fully drawn plastic comb integrally produced with the frame that are more rugged than that commercially available today.

### SUMMARY OF THE INVENTION

One of the unique features of the present invention is to construct honey supers that are so strong the entire box may be placed in an extractor and the honey extracted, without using a decapping knife to uncap the bee wax capped honey in the drawn foundation/comb.

Another key feature of the present invention is to manufacture plastic foundation/comb and frame which are unitarily extruded in an integral, one piece item useful in both the hive bodies and the honey supers. For honey supers, each unitary, one piece item may include a small plastic “honeybee egg” positioned in the center of each dimple of the foundation so as to discourage a queen bee from laying an egg (when the bees have fully drawn the dimple-cell into comb). If the unitary foundation and frame (one piece, not more) are to be used in the hive body, there is no honeybee egg unitarily extruded in each cell of the foundation, as this is where a beekeeper wants the queen bee to lay the eggs. On the other hand, plastic “honeybee eggs” in the dimples of foundation or in fully drawn plastic comb for use in honey supers act like a queen excluder, in theory, and control where the honey is and where the baby brood bees are.

Another key aspect of the present invention is to incorporate steel, or another strong metal into the ears of the plastic frame such that they can withstand very high extraction speeds.

Another key aspect of the present invention is to make the frames have side bar supports along the entire side (the entire height of the frame). In this manner, the box can be sized and designed such that the frames are tight against one another, spaced apart by the side bars, such that they fit very snugly within a box and yet bee space exists at the top and bottom of each frame to permit the honeybee to have access therein. This prevents bees being smashed by the movable loose fitting frames conventionally used today, during transportation of the hive. This feature also only permits honeybees to enter from the top or the bottom of a frame, and not around the side edge of a frame. Small hive beetles tend to congregate on the side wall of the hive body. Having tightly fitting frames prevents them from entering around the side edge thereby allowing the bees to more easily control the small hive beetles, keeping the beetles out of the brood and honey areas within the boundaries of the frame.

Another key aspect of the present invention is to construct the hive bodies and honey supers such that they nest within one another in a locking fashion so that the beekeeper is assured that they are vertical and in complete alignment with one another.

In the broadest sense, the present invention includes a unitarily extruded frame and foundation wherein the side bars of the frame are designed to close off any access to the bees, i.e., prevent bees from entering the side of any frame.

In the broadest sense, honey super foundation or comb are incorporated with a “plastic egg” in each cell of the foundation.

In the broadest sense, the present invention consists of a honey super with plastic frames and foundation or comb that snugly fit so that there is only space on the top and the bottom for honeybees to enter a particular frame foundation/comb.

Lastly, the present invention is directed to a unitary, integral, one-piece frame and fully drawn comb that is capable of withstanding high speed extraction.

### BRIEF DESCRIPTION OF THE DRAWINGS

The drawings are to aid in the understanding of the invention but are not to limit the invention in any manner inconsistent with the scope of the claims.

FIG. 1 shows a perspective exploded view of an entire beehive including a bottom board, hive body, honey super, inner cover and outer cover.

FIG. 2 is a partial enlarged perspective view of an integral hive body frame and foundation, with a cutaway portion to illustrate the metal support.

FIG. 3 is a partial enlarged perspective view of another embodiment of an integral frame and foundation of the honey super and having the “egg” positioned therein.

FIG. 4 is a partial enlarged perspective of another embodiment of an integral frame and fully drawn comb of a hive body or honey super.

FIG. 5 is a perspective view of an extractor and a honey super with frames being positioned therein.

FIG. 6 is a top view of an extractor with 4 honey supers therein, taken along line 6-6 in FIG. 5.

### DESCRIPTION OF THE PREFERRED EMBODIMENTS

The raw materials suitable for constructing an entire beehive for the present invention can comprise wood or plastic for the hive body and honey supers boxes. The material for the bottom board, inner cover and outer cover may also be wood or plastic. However, the frames for both the hive body and the honey super are entirely constructed of plastic along with the foundation or fully drawn comb. The foundation/comb and frames are of unitary construction so that they are one-piece integrally molded.

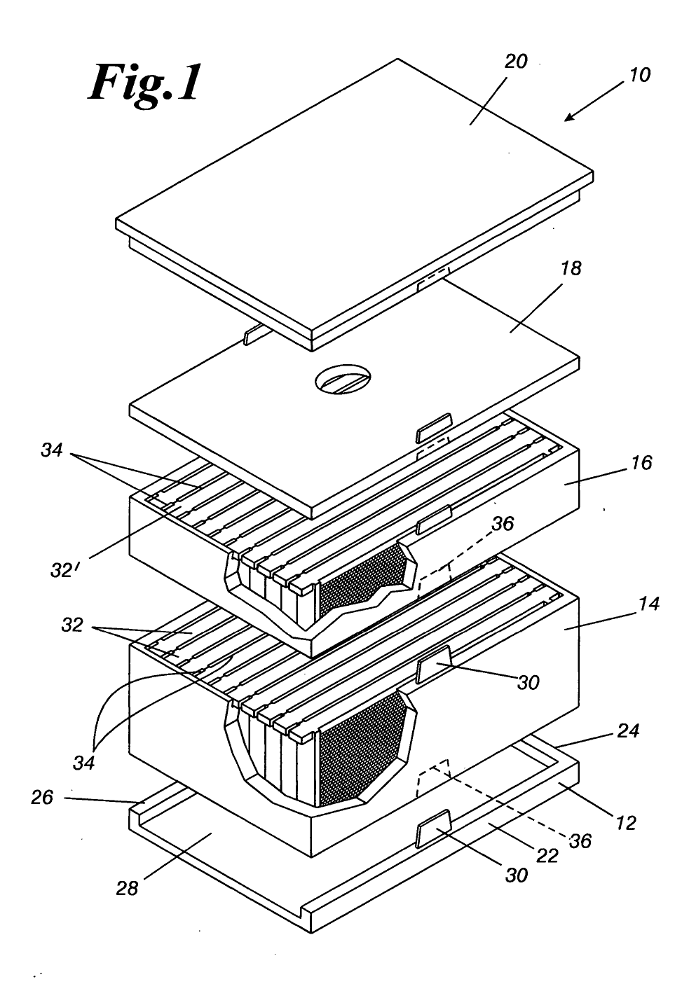

FIG. 1 illustrates the components of the present invention in detail, wherein the reference numeral 10 illustrates generally an entire beehive comprising a bottom board 12, a hive body 14, a honey super 16, an inner cover 18, and an outer cover 20. The bottom board 12 has three vertical walls 22, 24, and 26 which rise from the periphery of the flat board 28. Although not shown, a central portion of the board 28 may be constructed of screen (not shown) as is known to those skilled in the art, to allow for the control of varroa mites. When the hive body 14 sits upon the three vertical walls 22,24, and 26, the side of the flat board 28 without a vertical wall, forms an opening with the hive body, such that there is a space the height of the vertical walls, which permits the bees to have egress and ingress into the hive. Note that the bottom board 12 is generally longer than the hive body 14 such that it extends beyond the hive body to provide a small landing site for bees flying into or away from the hive. On one or more of the vertical wall portions 22, 24, 26 is a projection 30 extending upwardly and its purpose will be explained later. This projection 30 as shown, is a truncated quadrilateral upwardly tapered shape, a triangular shape or a semi-circular shape which allows the function to be easily engaged as will be explained later. Irrespective of the shape, the tapering of the projection 30 would be narrower at the top than at the bottom, and the bottom is that portion secured to the vertical walls. Although projection 30 is shown on the vertical wall, it can simply consist of a piece of metal secured to the inside walls of a box or a bottom board, on a piece of angle iron positioned in the inside corner of a box or bottom board.

The hive body 14 comprises four sides so as to form an open rectangular box and is sized, with respect to the present invention, to fit ten (10) frames 32 therein. These frames fit tightly within the box, such that there is no movement of the frames within the box especially when hives are being transported. This feature is contrary to present day hive bodies. Present day hive bodies that have 10 frames, can also accommodate 9 frames with a spacer. However these 10/9 frame hive bodies flop back and forth, side to side during movement (transportation) which crushes bees during transportation. If the transportation is for several days (East coast to West coast trip for example), then several thousand bees may be killed during this time. Most important, is that the queen herself is not killed. Because the hive contains only a single queen, this would devastate the hive.

Each hive body 14 has at least one projection 30 and a corresponding number of slots 36 on its bottom surface preferably within the box walls. The slot 36 is designed to cooperate with the projection 30 of the component below so as to accurately align each component of the hive with one another so that the entire hive is in perfect alignment. For example, each projection 30 on the bottom board 12 fits into a corresponding slot 36 on the hive body 14 shown in FIG. 1. Likewise, each projection 30 on the hive body 14 fits into a corresponding slot 36 on the honey super 16. Beekeepers may have, for example, two hive bodies 14, seven or eight honey super 16 (during the main honey flow), one inner cover 18 and an outer cover 20. All the projections 30 and slots 36 allow the complete hive to align with one another so that each component accurately positions itself with the component above and below it, except for the bottom board 12 and the outer cover 20 which have no component below and above them, respectively. Should the alignment projections be angle iron positioned in the corners, as stated previously, it will be important that the angle iron is sized so as not to interfere with the frames.

Conventionally frames are spaced apart to allow the bees to move between the frames. With the present invention, each frame 32 is tightly abutted to either the hive body 14, or to another frame 32 such that a gap 34 exists between either the hive body or between adjacent frames. This gap 34 is sized so as to consider the limitations of “bee space” which is roughly ⅜ of an inch. If the bee space is larger than this size, the bees tend to propolyze or add burr comb in this space to narrow it down to bee space, and if the gap 34 is smaller than bee space, then the bees cannot move between the frames (the gap is smaller than the size of the bees). The gap 34 extends continuously from the top of each frame to the bottom of each frame. Thus a bee entering the bottom of the hive, can crawl up any one of 11 gaps 34 that exist in a standard 10 frame hive body.

The honey super 16 is generally sized to be smaller than the hive body 14. This is because a hive body with a hive body frame (about 9-⅛ inches tall) if serving as a honey super, will weigh at least 90 pounds when full of honey. A beekeeper lifting this much weight during harvesting will soon develop a very sore back. The size of the typical honey super 16 is generally “medium” size (about 6-¼ inches tall) which holds about 40 pounds of honey in the entire honey super, or the “small” size (about 5-⅜ inches) which holds about 25 pounds of honey in the honey super. Although honey supers can be any size, these are the sizes that most bee equipment supply houses provide. Accordingly, the sizes of the frames 32′ in the honey super 16 are smaller in height than the size of the frames 32 in the hive body 14. However, they are constructed identically, with the same length, the same gap openings 34, etc. Therefore, the honey super, may have smaller frames 32′ with a smaller box or the same size frames employed in the hive body 14, with a corresponding larger box.

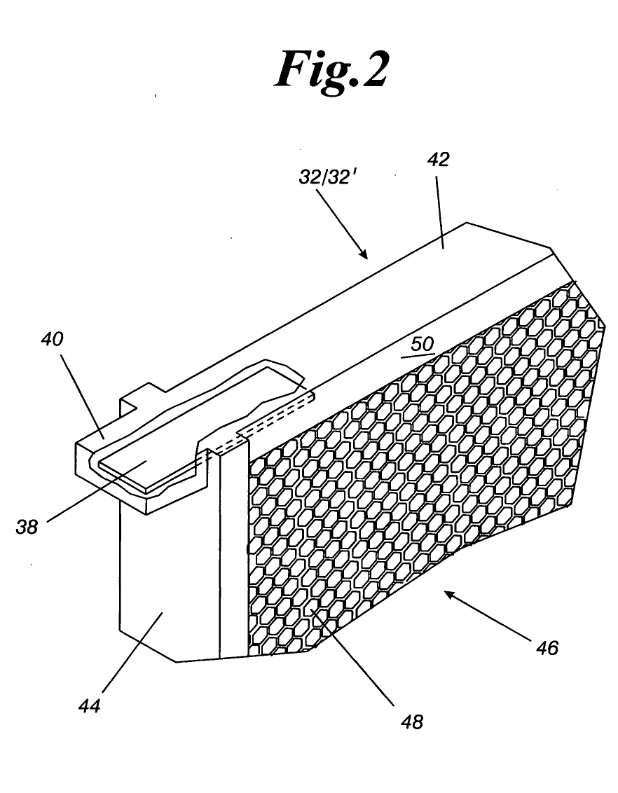

FIG. 2 is a partial enlarged perspective view of a frame. The frame 32/32′ has a cut away portion (for illustration purposes only) showing an imbedded piece of metal 38 designed to prevent the ears 40 from shearing or breaking when the frame 32/32′ is full of honey, for example. The shearing of the ears 40 is a common problem. Each frame 32/32′ has the top bar 42, two side bars 44, and a bottom bar, not shown. The ears 40 are actually each end of the top bar 42 that extend beyond the side bars 44. Bound within these four bars, is an integral plastic foundation 46 comprised of thousands of hexagonal dimples 48 on each side thereof. As shown in FIG. 2, the plastic foundation 46 is a thin sheet positioned in the middle of each of the bars 42, 44, etc. The bees will draw out from each face of the foundation 46 hexagonal tube shaped cells using beeswax and they will generally draw it out to the face 50 of the top bar 42. The tube shaped cells are sufficiently deep that baby brood bees, honey, and pollen can be stored therein. Note that the side bars 44 are larger (wider) than the top bar 42. This differential is bee space. It is approximately the space large enough to allow one bee to traverse from the top of a fully drawn comb up to a frame above it or to the bottom frames or board below it, etc. Two side-by-side frames have enough bee space to allow bees to simultaneously move on each face of the fully drawn comb.

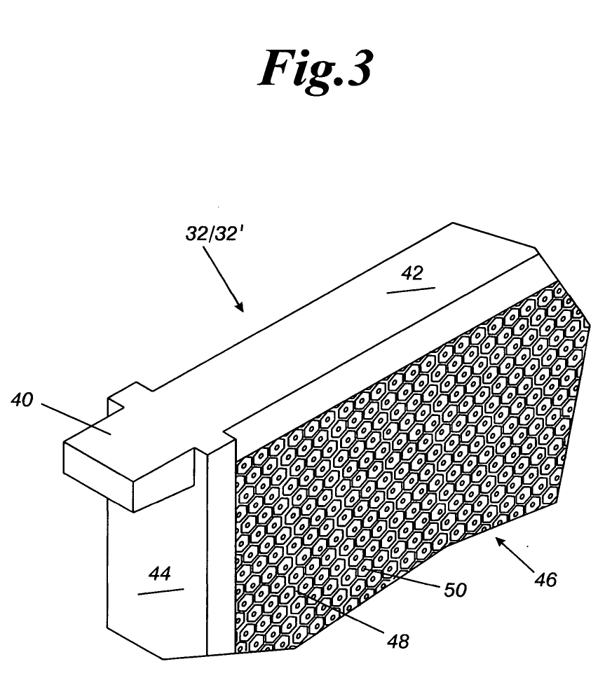

FIG. 3 illustrates another embodiment of the present invention. Shown is a frame 32′, with the plastic foundation 46, but each hexagonal dimple cell 48 has an artificial “egg” 50 embedded or integrally formed therein. The egg is approximately the size of an egg the queen bee would lay for baby brood bees. The embodiment illustrated in FIG. 3, would be employed in honey supers, for example with the theory being that the queen would not lay an egg in honeycomb cells 48, because each cell already has an egg. In theory, the queen would detect the artificial plastic egg 50 and not lay in these cells. Foundation having artificial eggs thereon act as a queen excluder, thus keeping the honey separate from the brood bees. This makes extraction of the honey easier. Since the entire foundation 46 would have eggs in each cell, the worker bees would use these cells to store honey. All other aspects of FIG. 3 are the same as those in FIG. 2, including the buried metal in the ears 40 for support to prevent the ears from shearing or otherwise breaking.

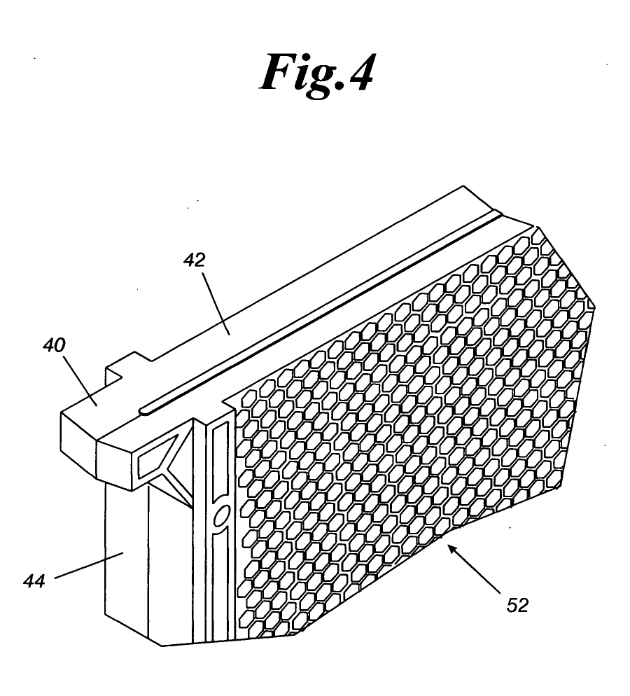

FIG. 4 illustrates an enlarged partial perspective view of yet another embodiment of the present invention. FIG. 4 illustrates a fully drawn plastic comb with the integrated plastic frame. In other words, there is no foundation plastic sheet as illustrated in FIGS. 2 and 3, but instead the frame and fully drawn comb are very similar to and represents a fully drawn comb of beeswax. In this manner, the queen and the worker bees can immediately utilize these fully drawn combs for baby bee brood, for the storage of honey, and the storage of pollen. Fully drawn comb have many advantages. Chief among the advantages are that: 1) It saves the bees time and effort in that bees do not have to draw out the comb as they must do with the FIGS. 2 and 3 components; therefore, the bees can immediately work on filling each comb with baby brood, honey and pollen. 2) Wax moths larva destroy fully drawn comb by eating the wax, honey, baby brood, etc. The plastic is too hard for the wax moth larva to eat and therefore they do not destroy the hive. Additionally, wax moth larvae cannot hide beneath the surface of the plastic fully drawn honeycomb like they do in wax honeycomb. They must now appear on the surface. The worker bees can easily destroy the larvae on the surface. 3) The biggest threat in beekeeping today is the Varroa mite. Studies have demonstrated that the normal size of honeycombs produced by wild bees is about 5.3 to 5.4 mm for worker bees and slightly larger (5.5-5.7 mm) for drone bees. When plastic fully drawn comb of the present invention is employed using smaller size comb, it is very effective in eliminating the Varroa mite. The exact mechanism as to why this works is unknown, but it is speculated that the smaller size doesn't allow sufficient space for the Varroa mite to exist.

The fully drawn plastic comb with integrated frame of the present invention can be made in any size. In particular, it is believed that a size from 4.3 to 5.1 mm from one side of the honeycomb to the opposite side of the honeycomb is useful in controlling Varroa mites in a bee colony. Preferably about 4.9 mm from one side of the honeycomb to the opposite side of the honeycomb's surface, is found to be most effective. When the honeycomb is sized between 5.3 mm and 5.7 mm, for example, certain bees like Russian bees, which seem to have some resistance toward Varroa mites, would more appreciate the extra space as it is more natural. Lastly, sizes greater than 5.7 mm, up to about 6.6 mm are useful for drone comb or primarily for the storage of honey in that these bigger combs hold more honey.

The frame/fully drawn comb illustrated in FIG. 4 has an integrated top bar 42 and side bar 44. As was described with respect to FIGS. 2 and 3, the side bars 44 are wider than the width of the top bar 44/fully drawn comb. This differential in width is bee space and thus allows a bee to walk on the surface of the fully drawn comb even when the frame/fully drawn comb is tightly adjacent to the box or another frame. Beekeepers desiring to use the frame/fully drawn comb in honey supers can appreciate that artificial eggs act as a queen excluder and thus the embodiments of FIGS. 3 and 4 can be combined.

At harvest time, a beekeeper would employ a knife, such as a hot knife, to cut the cappings or top portion of wax, from the top of the honeycomb thus exposing the honey. The honey still must be extracted from the individual combs. Conventionally, extractors have racks therein to hold frames such as those illustrated in FIGS. 2-4. The conventional racks rotate rapidly within the extractor to fling the honey out of the honeycomb. Generally bits of wax break away from the comb and are also flung outward with the honey. Each individual comb in a frame, points upwardly toward the top bar 42 about 7° to 12° from the horizontal, as is known. Accordingly, it is necessary in conventional extracting, to set the frames in the extractor racks wherein the top bar 42 is adjacent the wall of the extractor. This means, therefore, that each individual honeycomb is positioned such that it now projects toward the extractor wall. The present invention functions well for those beekeepers using a conventional extractor. A beekeeper can employ a knife and cut away the wax capping with either the plastic comb of FIG. 3 or the fully drawn foundation of FIG. 4, and mount these frames in a conventional extractor.

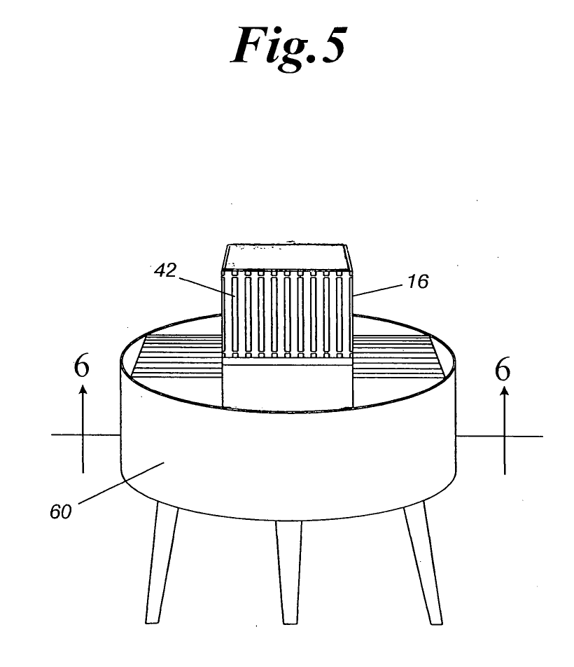

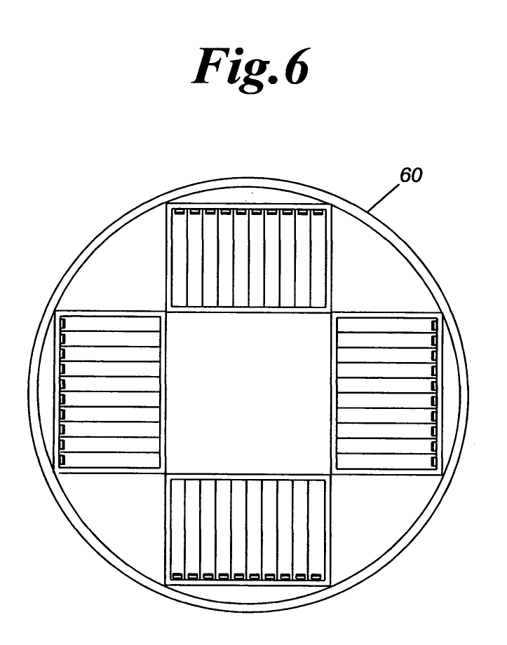

FIGS. 5 and 6 illustrate another concept of the present invention. Rather than position each individual frame in an extractor, the frames and boxes of the present invention are sufficiently strong that an entire honey super, filled with honey, can be positioned in an extractor as shown on FIG. 5. A key feature of this embodiment of the present invention is that the integral frame/fully drawn comb illustrated in FIG. 4 also requires very little bees wax to “cap” the honey. Accordingly, when extracting honey employing the frame/fully drawn comb, a high speed extractor (greater than about 1200 rpm) extracts the honey without uncapping. The higher speed “blows out” the wax capping and the honey within each comb. Essentially there is no more wax is in the honey than in a conventional extraction process (since there is very little wax used to cap the honey). In the fully drawn foundation of the present invention, a conventional extractor is unable to “blow out” the wax cappings. Further, this high speed method is a tremendous labor-saving advantage. No one is required to de-cap or uncap the honeycomb, and no one has to remove each frame and place it within the conventional extractor. The beekeeper merely place the entire honey super(s) in the extractor. The extractor 60 may hold any number of honey supers 16 so long as it is fairly balanced upon rotation. As illustrated in FIG. 6, four honey supers are shown therein. Thus in FIG. 6 the four honey supers can be extracted simultaneously. Note that the top bar 42 of the each frame in the honey super 16 will be positioned inside the extractor such that it is adjacent the inside wall of the extractor 60 as more easily seen in FIG. 6. This means the honey super had been rotated 90° from its position in the hive, i.e., it is now on its side edge (either the long or short side edge, as long as the top bar of the frames face the inside wall of the extractor). Of course, an extractor may have two, three, four or more honey supers therein as long as balance is created in the extraction process.

Thus it is apparent that there has been provided, in accordance with the invention, a beehive and/or components thereof that fully satisfy the objects, aims and advantages set forth above. While the invention has been described in conjunction with specific embodiments thereof, it is evident that many alternatives, modifications and variations will be apparent to those skilled in the art of the foregoing description. Accordingly, it is intended to embrace such alternatives, modifications, and variations as fall within the spirit and broad scope of the appended claims.

What is claimed is:

1) A method of extracting honey from a honeybee hive, comprising: separating the honey super(s) containing the frames of honey from the remainder of the hive components; placing the entire honey super(s) in an extractor such that the top bar of said frames are closest to the wall of the extractor; and rotating the extractor sufficiently to extract the honey.

2) The method of claim 1, wherein said frames of honey are not uncapped prior to the rotating step.

3) The method of claim 1, wherein said frames of honey are plastic fully drawn comb.

4) The method of claim 1, wherein said honey super(s) is/are rotated 90° from its position in said hive.

5) A honey super frame, comprising: a unitary integral plastic frame and foundation having a top bar, 2 side bars and a bottom bar with said foundation positioned between all of said bars, said side bars having a width wider than the top bar and bottom bar so as to create bee space, said foundation having hexagonal dimples formed therein, each of said dimples having an integrally formed plastic honeybee egg positioned centrally.

6) The honey super frame of claim 5, further having metal embedded in said top bar near each end thereof.

7) The honey super of claim 5, wherein said foundation is fully drawn comb.

8) A hive body or honey super, comprising: a open box, a plurality of unitary frame and foundations, each of said frame and foundations having a top bar, 2 side bars and a bottom bar with said foundation positioned between all of said bars, said side bars having a width wider than the top bar and bottom bar so as to create bee space, said foundation having hexagonal dimples formed therein, said plurality of said unitary frames and foundation secured in said box so as to form open gaps only at the bottom and at the top of each frame and foundation.

9) The hive body or honey super of claim 8, wherein said side bars continuously contact adjacent side bars for their entire length.

10) The hive body or honey super of claim 8, wherein said side bars of said unitary frame and foundations adjacent said box continuously contact said box along their entire length.

11) An extractor comprising means to hold a plurality of honey supers positioned so that the top of said frames are positioned adjacent said inner wall of said extractor.
